(19) United States
(12) Patent Application Publication
(10) Pub. No.: US 2019/0029778 A1
(43) Pub. Date: Jan. 31, 2019

(54) METHOD FOR CORRECTING A DENTAL PROSTHETIC MOUNTED UPON AN ANGULARLY-OFFSET INSTALLED ONE-PIECE MINIATURE DENTAL IMPLANT

(71) Applicant: IMPLANT SOLUTIONS, INC., Jupiter, FL (US)

(72) Inventors: Alan M. Miller, Port St. Lucie, FL (US); Craig W. Russo, Jupiter, FL (US)

(73) Assignee: IMPLANT SOLUTIONS, INC., Jupiter, FL (US)

(21) Appl. No.: 15/659,137

(22) Filed: Jul. 25, 2017

(51) Int. Cl. A61C 8/00

(52) U.S. Cl. CPC A61C 8/0053; A61C 8/0022; A61C 8/0012; A61C 8/0062; A61C 8/0075

(57) ABSTRACT

A method for correcting an angular offset of a dental prosthetic mounted atop an angularly-offset installed one-piece miniature dental implant having a ball-shaped head above a circular neck, includes steps of: (a) unseating the angularly-offset prosthetic; (b) removing a rubber O-ring disposed about the circular neck; (c) providing a replacement nylon cap and metal housing subassembly and incorporating the subassembly into a dental prosthetic cavity; (d) mounting the dental prosthetic upon the angularly-offset installed miniature implant; and (e) angularly translating the mounted dental prosthetic from a first offset angular orientation to a second non-offset angular orientation.

### FIELD OF THE INVENTION

The present disclosure relates generally to dental implants and, more particularly, to an improved titanium miniature dental implant assembly and a corresponding method of using the improved assembly to facilitate the correction of angularly offset installed miniature implants.

### BACKGROUND OF THE INVENTION

The present disclosure relates generally to dental implants and, more particularly, to an improved titanium miniature dental implant assembly and corresponding methods of using the improved assembly to facilitate the correction of angularly offset installed miniature dental implants.

Generally speaking, a dental implant is a titanium post, or titanium screw, that is surgically positioned into the jawbone beneath the gum line that allows a dental professional to mount prosthetic replacement teeth or a bridge into that area of the mouth. Typically, an implant is not as susceptible to coming loose like a denture often can. It is well known that dental implants also benefit general oral health because, unlike bridges, they do not have to be anchored to other teeth. Dentists can replace missing teeth with bridges, dentures or dental implants. Bridges and dentures are false/prosthetic teeth that sit on the gum's surface, but dental implants are inserted into the jawbone so that they are not removable. Conventionally, a periodontist or oral surgeon conducts a surgical procedure to place a titanium post having an abutment into the bone of the jaw, and then the bone fuses around an upper portion of the implant, commonly referred to as an abutment, over the course of three to six months. Once the abutment is fused in the bone, the implant is uncovered and then a small post is attached into the implant to function as an anchor to which artificial teeth can be attached. Titanium implants are preferred because Titanium fuses with bone through a process known as “Osseointegration.” Technically speaking, Osseointegration refers to a direct structural and functional connection between ordered, living bone and the surface of a load-carrying implant. Currently, an implant is considered osseointegrated when there is no progressive relative movement between the implant and the bone with which it has direct contact. This bone integration is formed instead of causing a foreign body reaction. Dental implants are often preferred in lieu of dentures because dental implants do not shift or slip in the way a denture often will.

More recently, miniature dental implants have become a preferred option for patients seeking to replace lost teeth but whom do not want (or cannot receive) conventional restorations. Furthermore, some individuals do not want invasive surgery required for regular implants, while others lack the bone mass in their jaws to hold them. While conventional, or regular, implants are typically 3.4 to 5.8 mm in width, miniature implants are typically on the order of 1.8 to 3.3 mm in diameter and about 10 to 15 mm in length (i.e. very narrow, about the size of a toothpick). Miniature implants support most types of replacement teeth, including dentures, bridges and fixed crowns. They may also be suitable for securing loose and lower arch dentures. While receiving regular implants takes several months and requires at least two dental appointments, dentists can usually install miniature implants in only one visit using local anesthesia and without sutures. Often, miniature implant recipients can use their new teeth that same day. In the case of dentures, the patient's denture is carefully adjusted by the dentist to allow it to be snap-fitted, or snapped, onto the newly-installed miniature implants. If successful, the miniature implants will firmly secure the lower denture and prevent slippage.

Conventional miniature dental implant technology relies upon the use of rubber O-rings that are typically mounted just beneath a ball-shaped attachment located at an upper, proximal, end of the titanium post. The use of O-rings is acceptable when all dental implants are placed, or installed, in a vertically-oriented, parallel alignment with one another. However, it is common for miniature dental implants to be placed in an angularly-offset, or off-vertical, non-parallel manner. When there is such an angular offset, the rubber O-rings—used to couple a dental prosthetic about the miniature titanium dental implant's ball-shaped attachment—do not fit properly and, consequently, patients are unable to enjoy the very benefits that miniature implants are intended to provide. With respect to typical one-piece titanium miniature dental implants, conventional rubber O-rings are sized, shaped and otherwise configured, to be snugly disposed about a necked portion of the mini-implant that extends upwards and transitions to the aforementioned ball-shaped attachment. Typically, the rubber O-ring is seated just beneath a 1.8 mm round ball. A major disadvantage of the use of conventional O-rings with miniature implants is that they do not enable angular correction of a dental prosthetic mounted upon the mini-implant, when the mini-implant has been installed in an off-vertical, or angularly-offset, non-parallel relationship vis-à-vis adjacent installed min-implants.

Accordingly, there is a long-felt but, as-of-yet, unmet need in the dental industry for an improved miniature dental implant assembly incorporating a mounting subassembly that—unlike a rubber O-ring—would enable simple angular correction of a dental prosthetic mounted upon a conventional one-piece miniature dental implant, where the one-piece mini-implant has been installed having an undesirable angular offset. Moreover, it would be highly desirable to provide a novel method for using such an improved miniature dental implant subassembly to correct for dentures previously mounted to one or more angularly-offset miniature titanium one-piece dental implants, without requiring removal of the respective one-piece miniature implants. Advantageously, this would enable dental patients to use existing, previously-installed, angularly-offset miniature dental implants to support an existing denture.

### SUMMARY OF THE INVENTION

In one general implementation present invention, a method is provided for correcting an angular offset of a dental prosthetic mounted atop an angularly-offset installed one-piece miniature implant of the type having a ball-shaped head an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the dental prosthetic having an interior cavity seated, or otherwise mounted, over the ball-shaped head and seated O-ring, the method including steps of:

(a) providing a unitary cap having a contiguous sidewall depending downwardly from a cap topside, the sidewall and topside each having an exterior surface together defining a cap exterior surface geometry, the sidewall terminating at a lower edge defining an opening into an interior cap cavity;

(b) providing a unitary cap housing having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;

(c) inserting the unitary cap into the unitary cap housing interior cavity until the cap is snugly seated and retained therein to define a cap-and-housing subassembly;

(d) removing the dental prosthetic mounted upon the angularly-offset installed one-piece miniature dental implant;

(e) removing the rubber O-ring from the shoulder and neck portions of the angularly-offset installed miniature dental implant;

(f) providing a dental prosthetic having a cavity extending into a bottom portion thereof and incorporating said cap-and-housing subassembly therein;

(g) mounting the dental prosthetic upon the angularly-offset installed one-piece miniature dental implant such that the ball-shaped head is snugly received within the interior cavity of the unitary cap; and

(h) angularly translating the mounted dental prosthetic from a first offset angular orientation to a second non-offset angular orientation.

In an aspect of the invention, the mounting step (g) may include snap-fit coupling the ball-shaped head of the angularly-offset installed one-piece miniature dental implant into the interior cavity of the unitary cap, such that the ball-shaped head functions as a ball joint to enable the dental prosthetic to be angularly rotated about the ball-shaped head.

In another aspect, the unitary cap may be formed from a thermoplastic polymer.

In another aspect, the thermoplastic polymer used to form the unitary cap may be nylon.

In another aspect, the method may include selecting a type of nylon, based upon desired cap properties for a particular patient, from the group of available nylons including nylon 6 (Cast Nylon), nylon 6,6 (Extruded Nylon), nylon 9, nylon 6/6-6, nylon 6/9, nylon 6/10, nylon 6/12, nylon 11 and nylon 12.

In another aspect, nylon caps may be provided having multiple degrees of retention, generally defined as the resistance (e.g. measured in grams) during removal of a nylon cap from an implant ball portion, wherein the nylon caps incorporate a visual identification (e.g. color coding) of the relative retention value. Significantly, the ability to select from nylon caps having a range of retention values overcomes limitations associated with conventional O-rings having a single, predetermined retention about an implant ball portion.

In another aspect, the step (a) of providing a unitary cap may include providing a unitary cap having a contiguous sidewall exterior surface defining at least one shoulder extending radially outward therefrom.

In another aspect, the step (b) of providing a unitary cap housing may include providing a unitary cap housing having an interior geometry defined by a housing interior sidewall surface defining a shoulder extending radially inward therefrom.

In another aspect, the step (c) of inserting may include inserting the unitary cap into the cap housing interior cavity until the shoulder extending radially outward from the cap sidewall exterior surface bears against the shoulder extending radially inward from the housing interior sidewall surface, thereby snugly seating and retaining the cap therein.

In another aspect, the dental prosthetic may be a prosthetic tooth, a denture or any other dental prosthetic that may be configured for use with a one-piece miniature dental implant.

In another aspect, the diameter of the ball-shaped heads of the one-piece miniature dental implants may be within a range of 1.0 mm to 6.0 mm, but is preferably within a range of 1.5 mm to 2.5 mm.

In another general implantation of the present invention, a method is provided for correcting the seating of a denture seated upon one-piece miniature dental implants previously installed within a mouth of a patient, where at least one of the dental implants is installed at an angle offset from a desired dental implant angle, the one-piece miniature dental implants each of the type having a ball-shaped head at an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the denture having a plurality of cavities extending into a denture base, each of the denture base cavities coupled to a corresponding one of the rubber O-rings disposed about the reduced-diameter necked portions of said plurality of one-piece miniature dental implants, the method including steps of:

(a) removing the denture from the underlying one-piece miniature dental implants;

(b) removing the rubber O-rings from the shoulder and neck portions of each of the previously installed one-piece miniature dental implants;

(c) providing a unitary cap having a contiguous sidewall depending downwardly from a cap topside, the sidewall and topside each having an exterior surface together defining a cap exterior surface geometry, the sidewall terminating at a lower edge defining an opening into an interior cap cavity;

(d) providing a unitary cap housing having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;

(e) inserting the unitary cap into the unitary cap housing interior cavity until the cap is snugly seated and retained therein to define a cap-and-housing subassembly;

(f) incorporating one cap-and-housing subassembly into each denture base cavity;

(g) resting the denture upon the plurality of one-piece miniature dental implants such that the cap-and-housing subassemblies inserted in the denture base cavities are disposed atop a corresponding one of the miniature dental implant ball-shaped heads; and

(h) re-seating the denture by urging the denture against the miniature dental implants such that each of the dental implant ball-shaped heads is snap-fittingly received into a corresponding interior cap cavity, such that a self-correcting one of the inserted cap-and-housing subassemblies that was previously resting upon the angularly-offset miniature dental implant maintains the desired dental implant angle once it has been re-seated.

In an aspect, during the step (h) of re-seating the denture the cap-and-housing subassembly that was previously resting upon the angularly-offset miniature dental implant is coupled to the underlying implant ball-shaped head such that the ball-shaped head functions as a ball joint allowing free rotation of the cap-and-housing subassembly in two planes at the same time in order to maintain a desired dental implant angle that is angularly offset from the previously-inserted miniature dental implant.

In a further exemplary implantation of the present invention, a method is provided for correcting the seating of a denture seated upon one-piece miniature dental implants previously installed within a mouth of a patient, wherein at least one of the dental implants is installed at an angle offset from a desired dental implant angle, the one-piece miniature dental implants each of the type having a ball-shaped head at an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the denture having a plurality of cavities extending into a denture base, each of the denture base cavities having an existing housing seated therein and coupled to a corresponding one of the rubber O-rings disposed about the reduced-diameter necked portions of the plurality of one-piece miniature dental implants, the method including steps of:

(a) unseating and removing the denture from the underlying one-piece miniature dental implants, the denture left with a plurality of cavities extending into a bottom side thereof, and each cavity having an existing housing seated therein corresponding to a respective one of the one-piece miniature dental implants;

(b) removing the rubber O-rings from the shoulder and neck portions of the previously installed one-piece miniature dental implants;

(c) providing a plurality of unitary caps each having a contiguous sidewall depending downwardly from a cap topside, the sidewall and topside each having an exterior surface together defining a cap exterior surface geometry, the sidewall terminating at a lower edge defining an opening into an interior cap cavity;

(d) providing a plurality of unitary cap housings each having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;

(e) inserting each of the unitary caps into one of the unitary cap housing interior cavities until the cap is snugly seated and retained therein, thereby defining a plurality of cap-and-housing subassemblies;

(f) seating each of the cap-and-housing subassemblies upon a corresponding one of the ball-shaped heads of the plurality of previously installed one-piece miniature dental implants in a preferred angular orientation;

(g) coring out the plurality of denture cavities, thereby removing a corresponding one of the previously installed metallic housings seated therein;

(h) introducing a quantity of a quick-curing adhesive into each one of the cored out denture cavities;

(i) re-seating the denture upon the miniature dental implants such that each adhesive-filled cavity is aligned with a corresponding one of the plurality of cored out denture cavities and each cap-and-housing subassembly is received within a corresponding one of the adhesive-filled denture cavities, such that the quick-curing adhesive envelopes the corresponding cap-and-housing subassembly to retain it within the corresponding cored-out denture cavity; and

(j) curing the quick-curing adhesive of each adhesive-filled denture cavity.

In an aspect, the quick-curing adhesive may be a cold curing acrylic capable of being cured within a time period of approximately two minutes to approximately four minutes.

In another aspect, the step (j) of curing the quick-curing adhesive may further comprise applying an ultraviolet (UV) light to each adhesive-filled denture cavity.

These and other features, aspects, and advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, where like numerals denote like elements and in which:

FIG. 1 is a top isometric view of a miniature dental implant assembly, shown in a fully-assembled state, for facilitating correction of angularly-offset installed implants, in accordance with an exemplary implementation of the present invention;

FIG. 2 is a front exploded view of the miniature dental implant assembly shown in FIG. 1;

FIG. 3 present a cross-sectional view of the fully-assembled miniature dental implant assembly, taken along section line 3-3 of FIG. 1;

FIG. 4 is a front elevation view, shown in cross-section for clarity, depicting: (a) a dental prosthetic member 60 and corresponding miniature dental implant assembly 10 of the type shown in FIGS. 1 and 3, wherein the dental prosthetic 60 is disposed about the cap-and-housing subassembly 30 of the present invention, and wherein a one piece miniature dental implant 20 is shown about to be installed into a patient jawbone 80 and overlying gum line 70 in a direction, D₁, that will result in an angular offset; and (b) an adjacent dental prosthetic member (60A) mounted upon a properly installed miniature dental implant assembly 20, 30 of the type shown in FIGS. 1 and 3 and absent any angular offset;

FIG. 5 presents a front elevation view, shown in cross-section for clarity, of the dental prosthetic 60, and corresponding cap-and-housing subassembly 30, mounted upon miniature dental implant 20, initially introduced in FIG. 4 and now shown following installation at angular offset (O); and

FIG. 6 presents a front elevation view, shown in cross-section for clarity, of the dental prosthetic 60, and corresponding cap-and-housing subassembly 30, mounted upon miniature dental implant 20, as previously depicted in FIG. 5, but following angular rotation (B; FIG. 5) completely correcting for the angular offset (O).

Like reference numerals refer to like parts throughout the various drawing views.

### DETAILED DESCRIPTION OF THE INVENTION

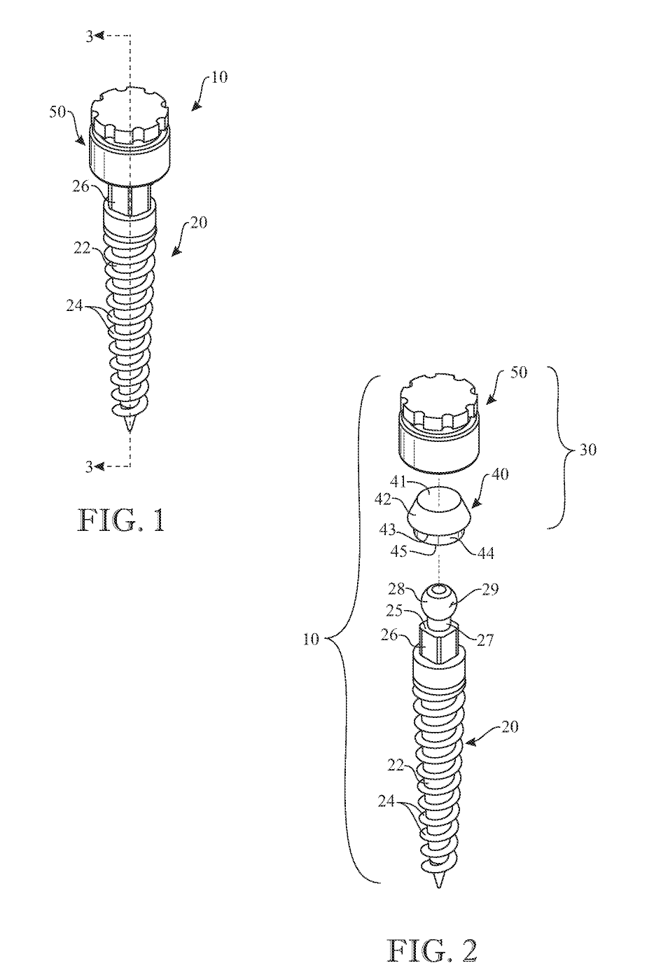

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

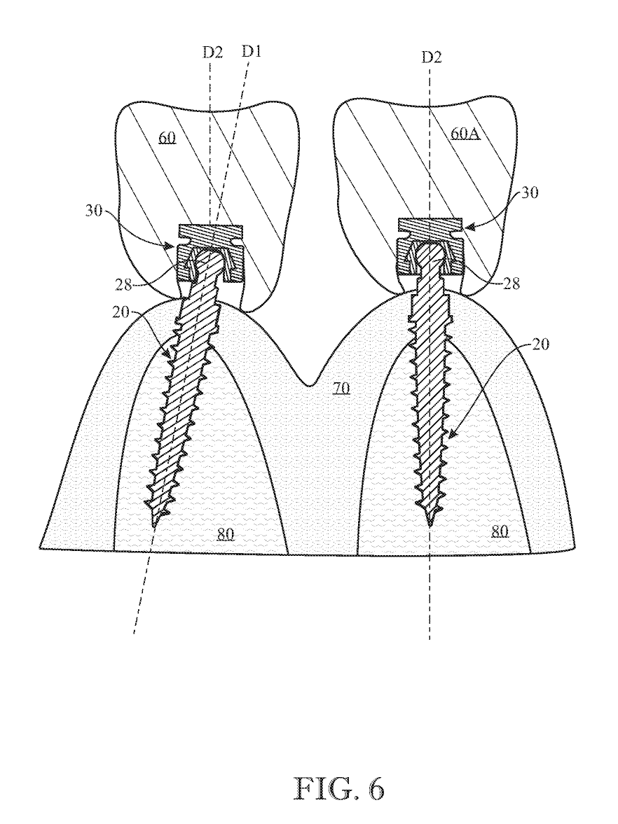

Referring now generally to accompanying FIGS. 1 through 6, in accordance with an implementation of the present invention, a miniature dental implant assembly (shown generally as reference numeral 10) is utilized to allow for angular correction of angularly-offset installed titanium one-piece miniature dental implants 20. Referring particularly to FIGS. 1 and 2, the present invention preferably utilizes a miniature dental implant assembly 10 that includes a one-piece titanium miniature dental implant 20 including a threaded shaft portion 22 having an exterior helix of self-tapping exterior threads 24 to facilitate insertion through a patient's gum tissue for anchoring into the patient's jawbone. The threaded shaft portion 22 is located below a non-circular upper abutment 26, which is conventionally used to facilitate engagement with a dental ratchet or other dental tool used to rotationally implant miniature dental implants through gum tissue and into jawbone, for secure anchoring of the one-piece miniature dental implant within the jawbone. Furthermore, a ball-shaped head 28, or spherical ball, having a spherical exterior surface 29, is provided at an uppermost, proximal end of the titanium miniature dental implant 20. The ball-shaped head 28 extends upwards from a reduced-diameter neck, or circular necked portion 28, which extending upwards from a shoulder 25 about which a conventional O-ring (not shown) has been previously mounted, as is well known and conventional in the miniature dental implant field of dentistry.

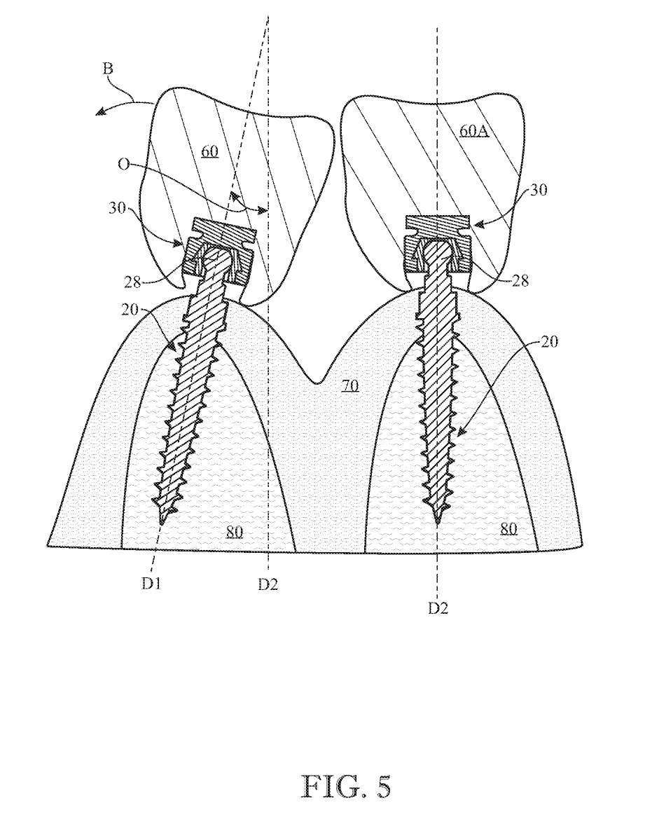

However, in accordance with preferred implementations of methods of the present invention, a cap 40 and a cap housing 50 are employed, as a cap-and-housing subassembly 30, in lieu of the conventional rubber O-ring. Significantly, as further described herein, the cap-and-housing subassembly 30, once seated upon a corresponding ball-shaped head 28 of the one-piece miniature dental implant 20, can be easily manipulated for angular rotation about the ball-shaped head. Referring briefly to FIG. 5, this particular coupling engagement of the cap-and-housing subassembly 30 to the underlying implant ball-shaped head 28 enables simultaneous free rotation of the cap-and-housing subassembly in two planes in order to enable the cap-and-housing subassembly, and a corresponding dental prosthetic seated thereon, to maintain a preferred orientation in alignment with a desired miniature dental implant installation direction, D2, that is angularly offset, O, from an insertion direction, D1, defined by the central longitudinal axis of the previously inserted miniature dental implant.

Again, conventional miniature dental implants 20 utilize rubber O-rings disposed beneath the ball-shaped heads 28 to couple a dental prosthetic thereto. In instances where one or more supporting miniature dental implants are not inserted in a preferred direction a prosthetic tooth seated upon an angularly offset implant will cause the O-ring to have an undesirable, often uncomfortable, fit, and patients are left unable to enjoy the benefits of having miniature implants. Conventional O-rings are designed to fit below a 1.8 mm round ball attachment portion at the proximal end of the post. Conventional O-rings do not allow for angular manipulation of the placed prosthetic tooth seated thereon.

Similarly, in instances where a plurality of conventional miniature dental implants are being used to secure a denture within a patient's mount, implants inserted in a direction, D1, that is angularly offset from implants inserted in a desired direction, D2, will be improperly coupled to corresponding O-rings disposed upon misaligned miniature dental implants, resulting in improper denture seating that causes discomfort to the patient.

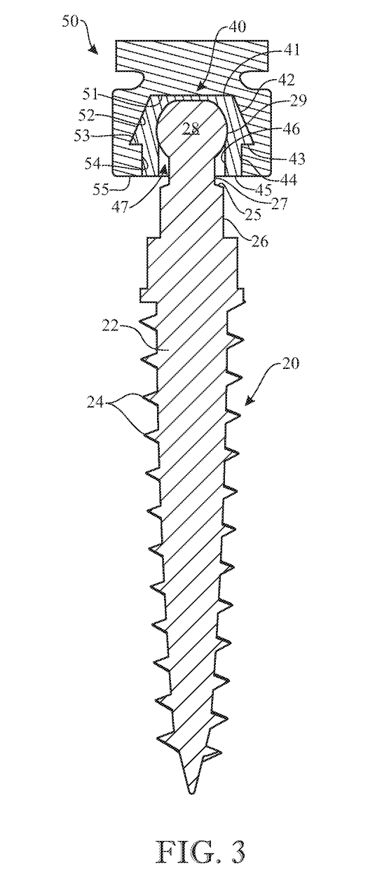

In a preferred implementation, a one-piece nylon cap, shown generally by reference numeral 40, is provided. The nylon cap may be formed from a particular type of nylon that will result in a formed cap having structural properties preferred for a specific patient's needs. Accordingly, while conventional miniature dental implants incorporate a single type of rubber O-ring, the improved methods described herein utilize thermoplastic caps that can be provided having varying structural properties chosen in accordance with a particular patient's needs. The preferred choice of cap material is nylon. Referring particularly to FIGS. 2 and 3, cap 40 may include a top side 41, having a sidewall depending downwardly therefrom. More specifically, the side wall has an upper sidewall portion that includes an outwardly-tapered exterior sidewall surface 42 terminating at a lower edge 43, and a vertically-oriented lower sidewall portion 44 terminating at a lower edge 45. The lower edge 45 defines an opening into an interior cap cavity, which is defined by an interior surface 46 defining a cap interior cavity. Significantly, when the cap 40 is seated upon ball-shaped head 28 a gap 47 is defined between interior cavity surface 46 and circular neck 27, as well as between cap interior surface 46 and a lower portion of exterior surface 29 of ball-shaped head 28. As further described herein below, gap 47 allows for angular rotation of cap 40 about ball-shaped head 28 and circular neck 27. Cap 40 is provided inserted within an interior cavity of a cap housing 50.

The cap housing 50 is preferably a conventional metallic housing used with miniature dental implants. Referring now particularly to FIGS. 3-6, cap housing 50 preferably has an interior cavity defined by an upper surface 51, an outwardly-tapered upper surface 52, a vertical lower surface 54, a shoulder 53 joining surfaces 52 and 54, and a lower edge 55. Accordingly, the housing interior cavity surfaces preferably define a housing interior having a geometry that substantially conforms to the exterior surfaces 41, 42, 43 and 44, which define the exterior geometry of cap 40. Furthermore, when cap 40 is properly seated within the interior of housing 50 it is preferred that the lower edge 45 of cap 40 is substantially aligned, or shares a common plane, with the corresponding lower edge 55 of housing 50. Significantly, during insertion of cap 40 into cap housing 50 the lower edge 43 of outwardly-tapered upper sidewall 42 of cap 40 bears against housing interior shoulder 53 to effectively retain cap 40 within the interior cavity of housing 50.

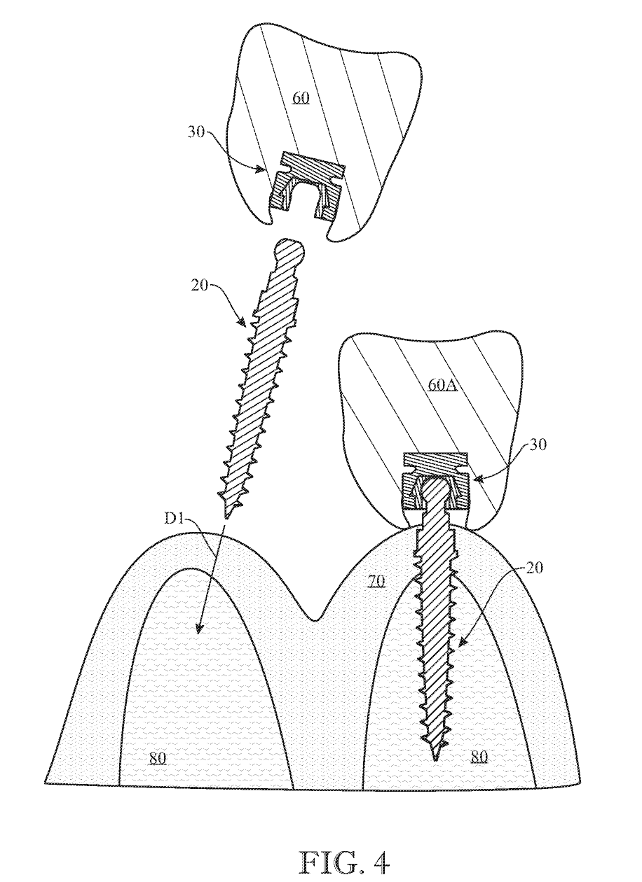

Significantly, the present invention substitutes the use of a conventional O-ring with a cap 40 snugly seated within cap housing 50, to create cap-and-housing subassembly 30. Subsequently, the cap-and-housing subassembly 30 can be mounted upon the ball-shaped head 28. Significantly, this arrangement allows for angular manipulation of, for example, a prosthetic tooth, disposed over the cap-and-housing subassembly 30. Consequently, when a miniature implant has been installed in a direction (e.g. D1 in FIGS. 4-6) that is angularly offset from a desired insertion direction (e.g. D2 in FIGS. 4-6) the cap-and-housing subassembly 30 enables a dentist to angularly manipulate the cap-and-housing subassembly 30 about the ball-shaped head 28 to correct for the aforementioned angular offset of the improperly installed miniature implant.

Furthermore, where the dental prosthetic is a denture seated upon a plurality of underlying miniature dental implants, the cap-and-housing subassembly 30 facilitates self-correction of a cap-and-housing subassembly 30 coupled to a ball-shaped head 28 of an improperly installed miniature implant. In other words, the corresponding cap-and-housing subassembly 30 will automatically rotate about ball-shaped head 28 such that it retains a proper central axis of alignment that is parallel to a corresponding central axis of a preferred vertical miniature implant direction of installation, D2.

Referring now to FIGS. 1-6, and particularly to FIGS. 4-6, in accordance with a preferred implementation a method is provided that corrects improperly seated patient dentures for patients having existing dentures seated upon a plurality of previously-installed conventional miniature dental implants having conventional rubber O-rings. Dentists commonly encounter patients having discomfort as a result of improper seating of such a conventional denture due to misalignment of a denture base cavity and an underlying angularly offset miniature denture. In such cases, the rubber O-ring may cause undesirable pressure, etc. at the site of such improper seating. Significantly, a method is provided for enabling the efficient correction of such denture misalignment without requiring removal of underlying improperly installed miniature dental implants.

Initially, the existing denture is uncoupled and removed from the underlying one-piece miniature dental implants, and the rubber O-rings are removed from the shoulder and neck portions of each of the previously installed one-piece miniature dental implants. Then, a single cap-and-housing subassembly 30 is incorporated into each one of the plurality or cavities extending into the denture base (i.e. the same cavities that were previously coupled to the ball-shaped heads 28 of the previously installed miniature dentures via the aforementioned, now removed, rubber O-rings).

Once the cap-and-housing subassemblies 30 have been properly incorporated into the corresponding denture base cavities such that each cap-and-housing subassembly 30 is securely retained within one of the denture base cavities, the denture is placed upon the underlying miniature dental implants such that each of the cap-and-housing subassemblies 30 rests upon a corresponding ball-shaped head 28 of an underling miniature dental implant 20. Then, the denture is re-seated by urging the denture against the miniature dental implants such that each of the dental implant ball-shaped heads is snap-fittingly received into an interior cavity of a corresponding cap 40. Significantly, any cap-and-housing subassemblies 30 that were resting upon the ball-shaped head 28 of an angularly-offset miniature dental implant will rotate about the ball-shaped head such that a substantially vertical central axis of the cavity is retained even though the vertical central axis is angularly offset vis-à-vis a non-vertical central axis of the corresponding one-piece miniature dental implant 20. In this manner, it can be said that the cap-and-housing subassemblies seated upon underlying miniature dental implants that previously installed in an improper installation direction self-correct. As a result, no additional pressure or other undesirable force is imparted to the mouth of the patient.

A primary market for the use of this novel method is refitting elderly individuals having existing dentures. Utilizing previously placed miniature dental implant posts, the conventional O-rings are efficiently and effectively removed and replaced with the cap-and-housing subassembly 30 and the denture is re-seated such that any prior undesired force or contact is eliminated.

As previously described herein, a method is likewise provided for utilizing the cap-and-housing subassembly 30 with a dental prosthetic in the form of a prosthetic tooth and the like. Referring now particularly to FIGS. 4-6. Thus, even though a one-piece miniature dental implant is installed at an angle that leaves it in a non-parallel vertical alignment with adjacent properly oriented miniature implants (i.e. the non-parallel inserted miniature implant is placed angularly offset from the adjacent vertically-oriented posts) the incorporation of the cap-and-housing subassembly 30 will enable a dental professional to slightly angularly adjust the overlying prosthetic in order to maintain the associated prosthetic tooth in a proper orientation.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence. For example, while the present disclosure primarily provides exemplary implementations of the present invention vis-à-vis miniature dental implants, it will be readily apparent to those skilled in the dental arts that the scope of the invention is intended to include application to conventional two-piece dental implant abutments and the like.

What is claimed is:

1. A method for correcting an angular offset of a dental prosthetic mounted atop an angularly-offset installed one-piece miniature dental implant, the angularly-offset installed miniature implant of the type having a ball-shaped head at an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the dental prosthetic having an interior cavity mounted over the ball-shaped head and seated O-ring, the method comprising steps of:
providing a unitary cap having a contiguous sidewall depending downwardly from a cap topside, the sidewall and topside each having an exterior surface together defining a cap exterior surface geometry, the sidewall terminating at a lower edge defining an opening into an interior cap cavity;
providing a unitary cap housing having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;
inserting the unitary cap into the unitary cap housing interior cavity until the cap is snugly seated and retained therein to define a cap-and-housing subassembly;
removing the dental prosthetic mounted upon the angularly-offset installed one-piece miniature dental implant;
removing the rubber O-ring from the shoulder and neck portions of the angularly-offset installed miniature dental implant;
providing a dental prosthetic having a cavity extending into a bottom portion thereof and incorporating said cap-and-housing subassembly therein;
mounting the dental prosthetic upon the angularly-offset installed one-piece miniature dental implant such that the ball-shaped head is snugly received within the interior cavity of the unitary cap; and
angularly translating the mounted dental prosthetic from a first offset angular orientation to a second non-offset angular orientation.

2. A method for correcting an angular offset of a dental prosthetic as recited in claim 1, wherein the step of mounting further comprises:
snap-fit coupling the ball-shaped head of the angularly-offset installed one-piece miniature dental implant into the interior cavity of the unitary cap, such that the ball-shaped head functions as a ball joint enabling the dental prosthetic to be angularly rotated about the ball-shaped head.

3. A method for correcting an angular offset of a dental prosthetic as recited in claim 1, wherein the step of providing a unitary cap further comprises providing a unitary polyamide cap.

4. A method for correcting an angular offset of a dental prosthetic as recited in claim 3, wherein:
the step of providing a unitary cap further comprises providing a unitary cap having a contiguous sidewall exterior surface defining at least one shoulder extending radially outward therefrom;
the step of providing a unitary cap housing further comprises providing a unitary cap housing having an interior geometry defined by a housing interior sidewall surface, the interior sidewall surface defining a shoulder extending radially inward therefrom; and
the step of inserting further comprises inserting the unitary cap into the unitary cap housing interior cavity until the shoulder extending radially outward from the cap sidewall exterior surface bears against the shoulder extending radially inward from the housing interior sidewall surface to snugly seat and retain the cap therein.

5. A method for correcting an angular offset of a dental prosthetic as recited in claim 1, wherein the dental prosthetic further comprises a denture.

6. A method for correcting the seating of a denture seated upon a plurality of one-piece miniature dental implants installed within a mouth of a patient, one of said dental implants installed having an angular offset from a desired dental implant angle, the one-piece miniature dental implants each of the type having a ball-shaped head at an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the denture having a plurality of cavities extending into a denture base, each of the denture base cavities coupled to a corresponding one of the rubber O-rings disposed about the reduced-diameter necked portions of said plurality of one-piece miniature dental implants, the method comprising steps of:
removing said denture from the underlying one-piece miniature dental implants;
removing the rubber O-rings from the shoulder and neck portions of each of the previously installed one-piece miniature dental implants;
providing a unitary cap having a contiguous sidewall depending downwardly from a cap topside, the sidewall and topside each having an exterior surface together defining a cap exterior surface geometry, the sidewall terminating at a lower edge defining an opening into an interior cap cavity;
providing a unitary cap housing having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;
inserting the unitary cap into the unitary cap housing interior cavity until the cap is snugly seated and retained therein to define a cap-and-housing subassembly;
incorporating one cap-and-housing subassembly into each denture base cavity;
resting said denture upon said plurality of one-piece miniature dental implants such that the cap-and-housing subassemblies inserted in the denture base cavities are disposed atop a corresponding one of said miniature dental implant ball-shaped heads; and
re-seating said denture by urging the denture against the miniature dental implants such that each of the dental implant ball-shaped heads is snap-fittingly received into a corresponding interior cap cavity, a self-correcting one of the inserted cap-and-housing subassemblies previously resting upon the angularly-offset miniature dental implant maintaining said desired dental implant angle once seated.

7. A method for correcting an angular offset of a dental prosthetic as recited in claim 6, wherein the step of providing a unitary cap further comprises providing a unitary polyamide cap.

8. A method for correcting an angular offset of a dental prosthetic as recited in claim 7, wherein:
the step of providing a unitary cap further comprises providing a unitary cap having a contiguous sidewall exterior surface defining at least one shoulder extending radially outward therefrom;
the step of providing a unitary cap housing further comprises providing a unitary cap housing having an interior geometry defined by a housing interior sidewall surface, the interior sidewall surface defining a shoulder extending radially inward therefrom; and
the step of inserting further comprises inserting the unitary cap into the unitary cap housing interior cavity until the shoulder extending radially outward from the cap sidewall exterior surface bears against the shoulder extending radially inward from the housing interior sidewall surface to snugly seat and retain the cap therein.

9. A method for correcting the seating of a denture seated upon a plurality of one-piece miniature dental implants installed within a mouth of a patient, one of said dental implants installed having an angular offset from a desired dental implant angle, the one-piece miniature dental implants each of the type having a ball-shaped head at an upper proximal end thereof, the ball-shaped head extending upwards from a reduced-diameter necked portion, the reduced-diameter necked portion extending upwards from a shoulder portion, and a rubber O-ring seated upon the shoulder portion and disposed about the necked portion, the denture having a plurality of cavities extending into a denture base, each of the denture base cavities coupled to a corresponding one of the rubber O-rings disposed about the reduced-diameter necked portions of said plurality of one-piece miniature dental implants, the method comprising steps of:
(a) unseating and removing the denture from the underlying one-piece miniature dental implants, the denture left with a plurality of cavities extending into a bottom side thereof, and each cavity having an existing housing seated therein corresponding to a respective one of the one-piece miniature dental implants;
(b) removing the rubber O-rings from the shoulder and neck portions of the previously installed one-piece miniature dental implants;
(c) providing a plurality of unitary caps each having a contiguous sidewall depending downwardly from a cap topside, the sidewall and topside each having an exterior surface together defining a cap exterior surface geometry, the sidewall terminating at a lower edge defining an opening into an interior cap cavity;
(d) providing a plurality of unitary cap housings each having a contiguous housing sidewall depending downwardly from a housing topside, the housing sidewall terminating at a housing lower edge defining an opening into an interior housing cavity, the housing interior cavity having a size and geometry enabling the unitary cap to be snugly received and retained therein;
(e) inserting each of the unitary caps into one of the unitary cap housing interior cavities until the cap is snugly seated and retained therein, thereby defining a plurality of cap-and-housing subassemblies;
(f) seating each of the cap-and-housing subassemblies upon a corresponding one of the ball-shaped heads of the plurality of previously installed one-piece miniature dental implants in a preferred angular orientation;
(g) coring out the plurality of denture cavities, thereby removing a corresponding one of the previously installed housings seated therein;
(h) introducing a quantity of a quick-curing adhesive into each one of the cored out denture cavities;
(i) re-seating the denture upon the miniature dental implants such that each adhesive-filled cavity is aligned with a corresponding one of the plurality of cored out denture cavities and each cap-and-housing subassembly is received within a corresponding one of the adhesive-filled denture cavities, such that the quick-curing adhesive envelopes the corresponding cap-and-housing subassembly to retain it within the corresponding cored-out denture cavity; and
(j) curing the quick-curing adhesive of each adhesive-filled denture cavity.

10. A method as recited in claim 9, wherein the quick-curing adhesive further comprises a cold cure acrylic composition.
